(19) United States
(12) Patent Application Publication
(10) Pub. No.: US 2014/0287795 A1
(43) Pub. Date: Sep. 25, 2014

(54) MOBILE TERMINAL AND METHOD OF SETTING CLOCK FOR COMMUNICATION INTERFACE

(71) Applicant: Pantech Co., Ltd., Seoul (KR)

(72) Inventor: Hyeong-Chan LEE, Goyang-si (KR)

(73) Assignee: Pantech Co., Ltd., Seoul (KR)

(21) Appl. No.: 14/139,181

(22) Filed: Dec. 23, 2013

(30) Foreign Application Priority Data
Mar. 19, 2013 (KR) 10-2013-0029338

(51) Int. Cl. H04L 7/00; H04W 88/02

(52) U.S. Cl. CPC H04L 7/0004; H04W 88/02
USPC 455/550.1

(57) ABSTRACT

A mobile terminal and method for controlling a clock signal of a communication interface between components of the mobile terminal are provided. The method includes determining a reference frequency of the clock signal, the reference frequency being determined based on an operating frequency band of a radio frequency (RF) system of the terminal, and transmitting the clock signal via the communication interface using the determined reference frequency.

### CROSS-REFERENCE TO RELATED APPLICATION

This application claims priority from and the benefit under 35 U.S.C. §119(a) of a Korean Patent Application No. 10-2013-0029338, filed on Mar. 19, 2013, which is incorporated herein by reference for all purposes as if fully set forth herein.

### BACKGROUND

1. Field

The following description relates to a mobile terminal, and more particularly, to a communication interface for processing a large amount of data.

2. Discussion of the Background

FIG. 1 is a diagram illustrating a parallel interface configuration of a mobile terminal according to the related art, and FIG. 2 is a diagram illustrating waveforms for digital communication in the interface configuration of FIG. 1 according to the related art.

A data interface method between a Mobile Station Modem (MSM) 10 and a display (for example, LCD (a liquid crystal display)) 20, of a mobile phone is a low-speed parallel bus interface method, which is a digital communication method using a square wave (a clock component) as the waveforms shown in FIG. 2, and requires 18-bit data lines and 5 control lines. When the mobile station modem 10 writes or reads data after a chip select signal (CS/) is activated, 18-bit data buses (D[0:17]) are used as parallel buses and suitably controlled and operated according to a data throughput. The data throughput is at most 256 Kbps. Accordingly, the above-described low-speed parallel bus interface method is suitable for a mobile phone with small data throughput. However, the method is not suitable for a mobile terminal, such as an advanced smart phone to which various hardware components, e.g., a display, a camera, and so on, are applied. In order to process a large amount of data during data communication, the advanced mobile terminal requires a high-speed digital interface.

FIG. 3 is a diagram illustrating a serial interface configuration of a mobile terminal according to a MIPI configuration, and FIG. 4 is a diagram illustrating waveforms for digital communication in the interface configuration of FIG. 3.

An example of the interface method of FIG. 3 is a MIPI (Mobile Industry Processor Interface), which is used for smart phones recently. As is well known, the MIPI is a group name established by numerous parties including Nokia, Intel, and so on to optimize an interface between the mobile terminal and a peripheral device, and also an open standard of a mobile application and a processor. The interface method between a modem 30 and a display 40 of FIG. 3 is a digital communication method using a square wave as the waveforms shown in FIG. 4, and is a high-speed serial communication method using a clock within 500 MHz, and requires 8 data lines and 2 control lines. The interface method of FIG. 3 has fewer number of data lines and control lines and performs a data communication by fixing one specific clock through a relatively high bandwidth (within 500 MHz), in comparison with the bus interface method of FIG. 2. When a maximum MIPI clock is fixed as 500 MHz, the data throughput becomes approximately 1 Gps. Therefore, the MIPI enables high-speed signal processing.

However, the interface method of FIG. 3 requires a square wave having a clock of a high frequency, and a number of multiplied frequencies within the clock are mixed. In this case, if the multiplied frequencies become hundreds of MHz, the multiplied frequencies are radiated as noises to a surface and a periphery of the display which is not shielded and may have a direct effect on a Radio Frequency (RF) system as noise and/or interference, thereby degrading the system performance.

According to the MIPI communication method, one clock period constitutes 2 data bits. The method is generally used by setting an arbitrary clock of a maximum of 1 Gbps, that is, 500 MHz, within a usable range, and the multiplied frequencies within the set clock operate as the noise to the RF systems having various constructions, thereby degrading the system performance. If a communication reference clock between the modem and the display is set to 220 MHz, which is a reference frequency, multiplied frequencies of 220 MHz including a twofold frequency (440 MHz), a threefold frequency (660 MHz), a fourfold frequency (880 MHz), a fivefold frequency (1100 MHz), a sixfold frequency (1320 MHz), a sevenfold frequency (1540 MHz), an eightfold frequency (1760 MHz), a ninefold frequency (1980 MHz), a tenfold frequency (2200 MHz), etc. may be generated. Further, 220/12=18.33 MHz, which is 220 MHz divided by 12, may additionally generate 11 frequencies at intervals of 18.33 MHz between each of the multiplied frequencies. Accordingly, if the multiplied MIPI clock is matched with or overlaps a frequency or a frequency band belonging to the RF systems (radio communication protocols, such as LTE, CDMA, GSM, WCDMA, GPS, etc.) supported in a smart phone, the MIPI clock becomes a noise component and operates as a factor degrading the RF system performance.

High-end devices require higher processing speed as well as communication speed between hardware components. As a result, a high-speed digital interface is needed to process many signals between the MSM and the peripheral apparatuses, such as the display, the camera, and so on, and the MIPI method is currently used for high-end devices, such as smart phones, as the high-speed digital interface method. The MIPI method has features in which the number of data and control lines of a serial interface method is fewer than the conventional bus interface method and high-speed signal processing may be established through a high bandwidth (within 1 Gbps, or 500 MHz). However, a high frequency of a clock of a square wave has a negative effect on various types of RF systems using various frequencies. Accordingly, the system performance of the RF system can be degraded.

### SUMMARY

Exemplary embodiments of the present invention provide a mobile terminal and method of setting a clock for communication interface.

Additional features of the invention will be set forth in the description which follows, and in part will be apparent from the description, or may be learned by practice of the invention.

Exemplary embodiments of the present invention provide a method for controlling a clock signal of a communication interface between components of a terminal, the method including: determining a reference frequency of the clock signal, the reference frequency being determined based on an operating frequency band of a radio frequency (RF) system of the terminal; and transmitting the clock signal via the communication interface using the determined reference frequency.

Exemplary embodiments of the present invention provide a mobile terminal to control a clock signal of a communication interface between components of the mobile terminal, the mobile terminal including: a radio frequency (RF) system to transceive a radio frequency signal to and from an access point; and a first component configured to determine a reference frequency of the clock signal, and to transmit the clock signal via the communication interface using the determined reference frequency, the reference frequency being determined based on an operating frequency band of the RF system of the mobile terminal.

Exemplary embodiments of the present invention provide a mobile terminal to control a communication between components of the mobile terminal, the mobile terminal including: a radio frequency (RF) system to transceive a radio frequency signal to and from an access point; and a processor configured to determine a reference frequency of a signal between the components, the reference frequency being determined based on an operating frequency band of the RF system of the mobile terminal. One of the components transmits the signal via a communication interface between the components using the determined reference frequency.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a parallel interface configuration of a mobile terminal according to the related art.

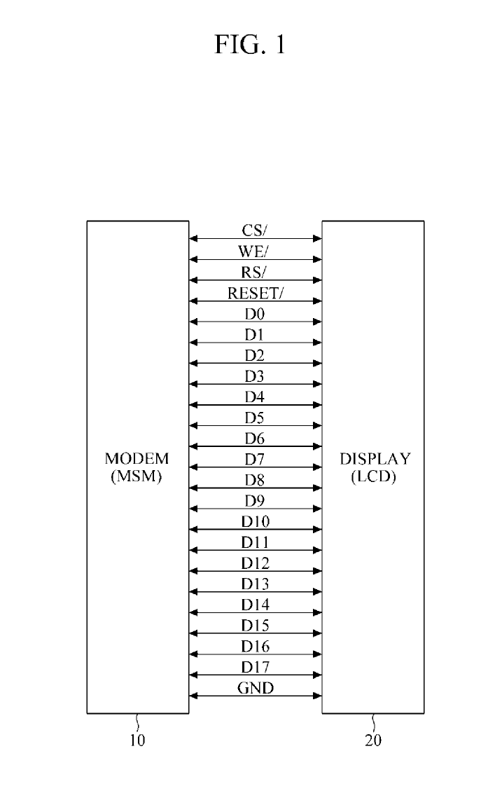

FIG. 2 is a diagram illustrating waveforms for digital communication in the interface configuration of FIG. 1 according to the related art.

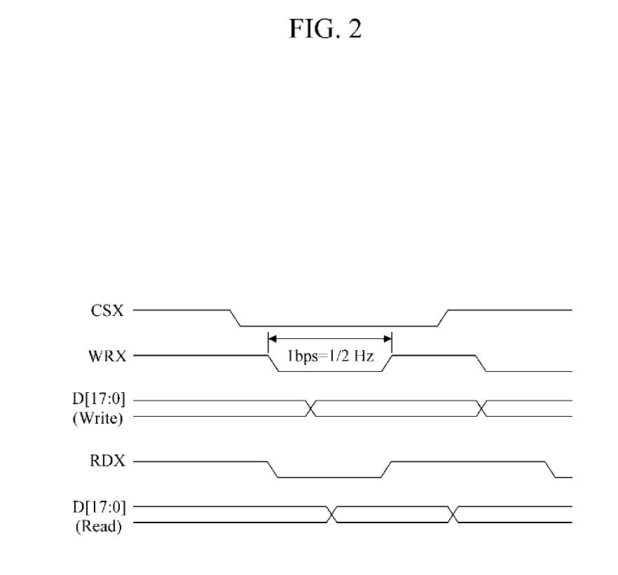

FIG. 3 is a diagram illustrating a serial interface configuration of a mobile terminal according to a MIPI configuration.

FIG. 4 is a diagram illustrating waveforms for digital communication in the interface configuration of FIG. 3.

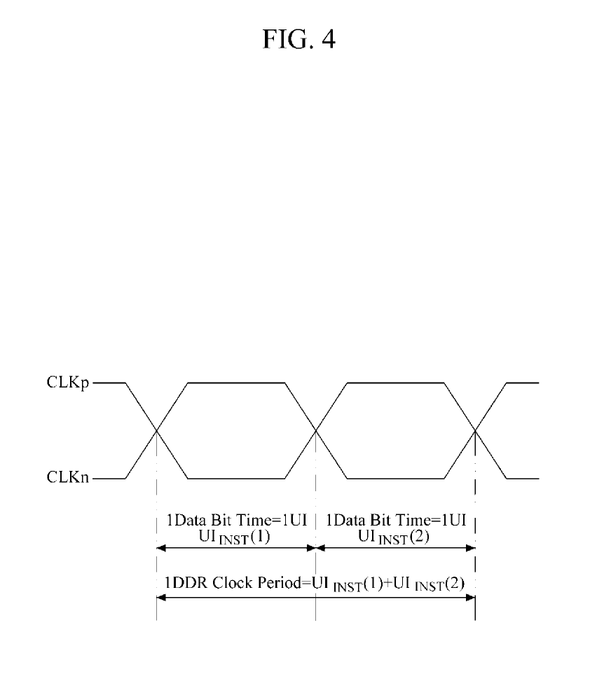

FIG. 5 is a diagram illustrating multiplied frequencies when setting a MIPI clock as 200 MHz according to an exemplary embodiment of the present invention.

FIG. 6 is a block diagram of a mobile terminal according to an embodiment of the present invention.

FIG. 7 is flowchart illustrating a clock setting method for a serial communication interface according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. It will be understood that for the purposes of this disclosure, “at least one of will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X).

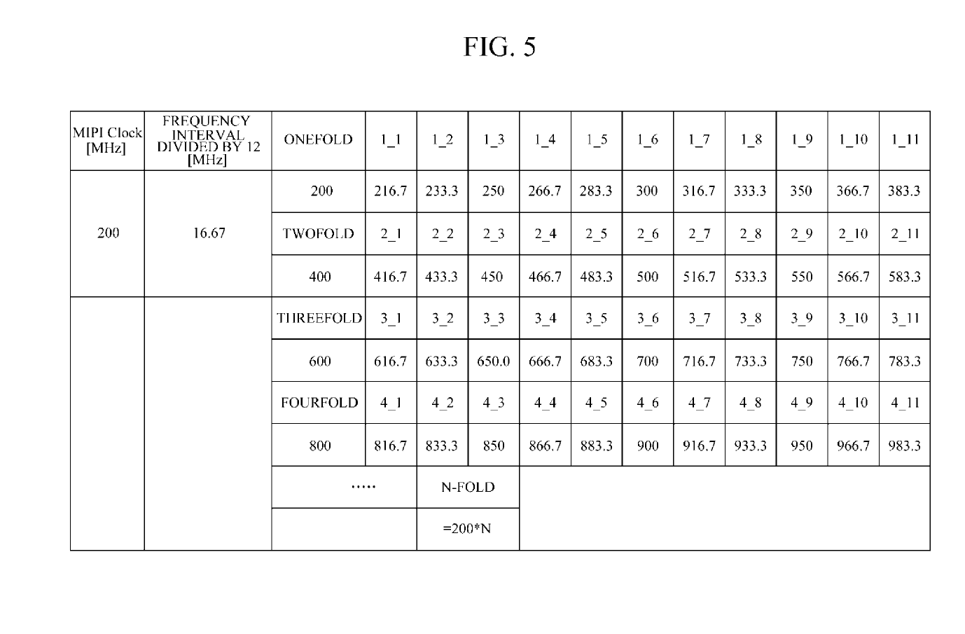

FIG. 5 is a diagram illustrating multiplied frequencies when setting a MIPI clock as 200 MHz according to an exemplary embodiment of the present invention.

According to the MIPI communication interface configuration as shown in FIG. 5, the configuration is generally used by setting an arbitrary clock of a maximum of 1 Gbps, that is, 500 MHz, within a usable range such that the reference frequency and multiplied frequencies do not significantly interfere with a communication frequency band of an embedded RF system. For example, if the MIPI clock usable range is 200 MHz to 500 MHz, a clock may be set by 500 KHz within the MIPI clock usable range. The set clock may be divided by 12 to be used as data and control register clocks. If a communication reference clock between the modem and the display is set to 200 MHz, which is a reference frequency, multiplied frequencies of the reference frequency including a twofold frequency (400 MHz), a threefold frequency (600 MHz), a fourfold frequency (800 MHz), a fivefold frequency (1000 MHz), a sixfold frequency (1200 MHz), a sevenfold frequency (1400 MHz), an eightfold frequency (1600 MHz), a ninefold frequency (1800 MHz), a tenfold frequency (2000 MHz), etc. may be generated. Further, 200/12=16.67 MHz, which is 200 MHz divided by 12, may additionally generate 11 frequencies at intervals of 16.67 MHz between the multiplied frequencies and between the reference frequency and the twofold frequency as shown in FIG. 5. If the multiplied MIPI clock is not substantially matched with or overlapped with a frequency or a frequency band belonging to the embedded RF systems, such as Long Term Evolution (LTE), LTE-Advanced (LTE-A), Code Division Multiple Access (CDMA), Global System for Mobile communications (GSM), Wideband CDMA (WCDMA), Global Positioning System (GPS), Wi-Fi, Bluetooth®, etc. supported in a smart phone, the MIPI clock is determined as an acceptable clock candidate.

Further, the 11 offsets of 16.67 MHz, 33.3 MHz, 50 MHz, 66.7 MHz, 83.3 MHz, 100 MHz, 116.7 MHz, 133.3 MHz, 150 MHz, 166.7 MHz, and 183.3 MHz may be added to the reference frequency or a multiplied frequency to calculate eleven offset frequencies from the reference frequency or from a multiplied frequency as shown in FIG. 5. These offset frequencies may be compared with an operating frequency band of an RF system and the reference frequency of a clock signal may be selected such that the offset frequencies do not correspond to the operating frequency band of an RF system.

For example, the Verizon® RF system used in North America will be explained below. A usage frequency of the Verizon® RF system used in North America is LTE B13/CDMA Dual/GSM Quad/WCDMA Quad/GPS. If the MIPI clock is set to 220 MHz, multiplied frequencies of the clock have a negative effect on a specific channel of LTE/GPS/CDMA. Additionally, if the MIPI clock is set to 220 MHz, 751.41 MHz, which is a 3_{—}5-fold frequency between a threefold frequency (660 MHz) and a fourfold frequency (880 MHz), is generated and may have a negative effect on 746 MHz to 756 MHz of the LTE frequency, the fourfold frequency (880 MHz) may have a negative effect on a portion of channel between 869 MHz and 894 MHz of the CDMA frequency, and 1577 MHz, which is a 6_{—}2-fold frequency, may have a negative effect on 1575.42 MHz of the GPS frequency. Further, if the MIPI clock is set to 234 MHz, a 3_{—}2-fold frequency becomes 741 MHz and a 3_{—}3-fold frequency becomes 760.5 MHz. Accordingly, the multiplied frequencies have no effect on the LTE frequency. However, a 3_{—}9-fold frequency becomes 877.5 MHz, thereby having a negative effect on a specific channel of the CDMA frequency.

If a set MIPI clock having a reference frequency does not provide a frequency value corresponding to an RF frequency employed by any of the embedded RF systems, the reference frequency may be referred to as an interference reducing reference frequency for the entire RF systems. If a set MIPI clock having a reference frequency does not provide a frequency value corresponding to or overlapping with an RF frequency employed by at least one of the embedded RF systems, the reference frequency may be referred to as an interference reducing reference frequency for at least one RF system.

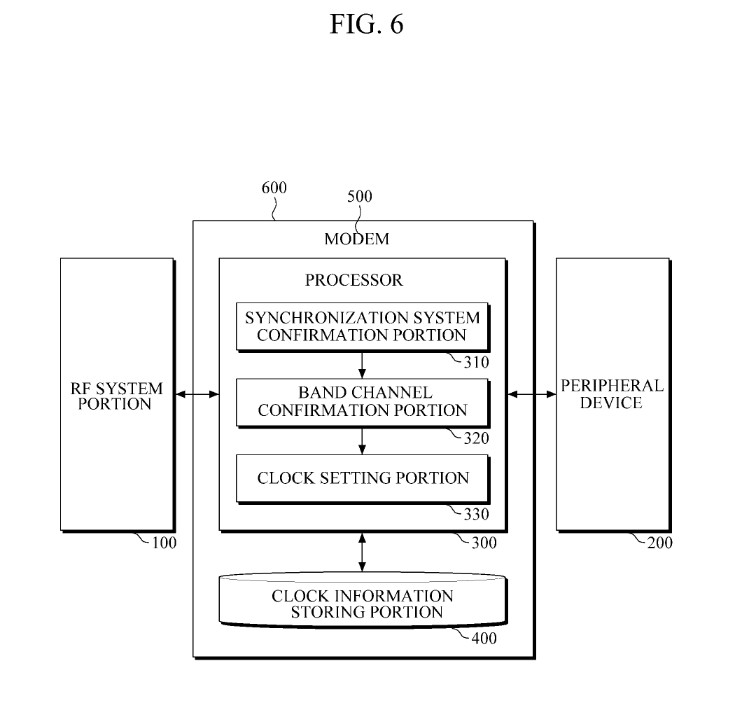

FIG. 6 is a block diagram of a mobile terminal according to an embodiment of the present invention.

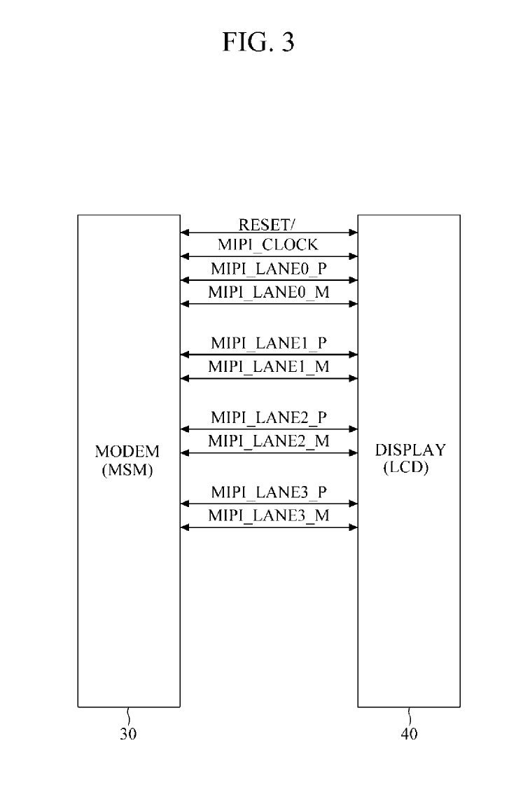

As shown in FIG. 6, a mobile terminal may include an RF system portion 100, a peripheral device 200, and a processor 300. The RF system portion 100 may include one or more RF systems. For example, at least a portion of a system among LTE (Long Term Evolution), CDMA (Code Division Multiple Access), WCDMA (Wideband Code Division Multiple Access), GSM (Global System for Mobile communications), GPS (Global Positioning System), and the like may be included in the RF system portion 100. The RF system portion 100 may include Radio Frequency Integrated Circuit (RFIC), and the RFIC may support LTE, CDMA, GSM, Universal Mobile Telecommunication System (UMTS), Enhanced Data rates for GSM Evolution (EDGE), High Speed Packet Access+ (HSPA+), and the like. The RF portion 100 and the processor 300 may be interfaced with bi-directional, high speed interface protocol. Further, the RF portion 100 may include antenna tuner, Bluetooth®, GPS, FM-Radio, Near Field Communication (NFC), Wireless Local Area Network (WLAN), Wi-Fi, Wireless Gigabit Alliance (WiGig), WirelessHD, and the like. The peripheral device 200 may be connected to the processor 300, and may particularly be a device communicating with the processor 300 through a high-speed serial communication interface. As an example, the peripheral device may be a display such as an LCD (Liquid Crystal Display), a camera module, a storage device, a bridge chip, a power management module including a battery, a speaker, an audio codec, a microphone, and so on. The processor 300 may perform data communication with the peripheral device 200 through the high-speed serial communication interface. For example, the high-speed serial communication interface may be MIPI (Mobile Industry Processor Interface) communication interface. A mobile station core portion 600 may include a processor 300, clock information storing portion 400, and a mobile station modem (MSM) 500. The modem 500 and the processor 300 may be integrated into one chip or may be connected via a communication interface. Specifically, the mobile station core portion 600 may include an application processor, a modem including a baseband circuit. The application processor and the modem may be interfaced with a high bandwidth serial interface according to MIPI configuration. Mobile Station Modem 30 shown in FIG. 3 may correspond to the mobile station core portion 600 of FIG. 6 and may include an application processor. Further, the interface between the MSM 30 and the display 40 illustrated in FIG. 3 and the interface between the processor 300 and the peripheral device 200 illustrated in FIG. 6 are exemplary, thus exemplary embodiments of the present invention are not limited thereto. For example, methods and configurations illustrated herein may be applied to various interfaces, e.g., an interface between an application processor and a modem, an interface between an application processor and a camera, an interface between an application processor and a WLAN module, and the like.

Further, the application processor may run an operating system, e.g., an iOS®-based operating system, Android™-based operating system, and the like, various user interface including Graphical user interfaces, and applications installed in the mobile terminal. Further, the application processor may interface to sensors, cameras, displays, microphones, storage devices, and the like. The modem may include an interface function to one or more mobile networks, and the modem may be a bridge between the application processor and the RFIC.

The processor 300 may determine a non-coherent clock, which is not coherent to a band channel of the RF system, as a clock for the high-speed serial communication interface communicating with the peripheral device 200. Further, the processor 300 may include a synchronization confirmation portion 310, a band channel confirmation portion 320, and a clock setting portion 330. The synchronization confirmation portion 310 may confirm an RF system synchronized with a base station among a plurality of RF systems pertaining to the RF system portion 100. The processor 300 may monitor and confirm an operation of the RF system portion 100. If the RF system synchronized with the base station is confirmed, the band channel confirmation portion 320 may confirm a band channel assigned from the base station for the synchronized RF system. The assigned band channel information may be provided from the base station, and the band channel confirmation portion 320 may receive and confirm the band channel information from the synchronized RF system among the RF systems of the RF system portion 100. If the band channel information may be confirmed, the clock setting portion 330 may determine the non-coherent clock for the high-speed serial communication interface by considering the confirmed band channel, and set the determined non-coherent clock as the clock for the high-speed serial communication interface. Here, the non-coherent clock may be a clock for which multiplied frequencies of the frequency of the clock do not have a significant negative effect on the synchronized RF system as noise or the multiplied frequencies of the frequency of the clock do not correspond to the frequencies of the synchronized RF system.

The clock setting portion 330 may determine a clock having a frequency, which may not operate as the noise with respect to the assigned band channel among usable frequencies available to be used as the clock (clock candidate frequencies). The clock setting portion 330 may decide a noise frequency range which is capable of operating as the noise to the assigned band channel, calculate multiplied frequencies which are capable of being generated by each of clock candidate frequencies, and determine a clock candidate frequency for which no multiplied frequency belongs to the noise frequency range. Through this process, if the clock candidate frequency for which the multiplied frequencies do not belong to the noise frequency range is found, the clock setting portion 330 may determine the clock candidate frequency as the non-coherent clock. Since the clock candidate frequency, which does not belong to the noise frequency range, may be plural, the clock setting portion 330 may arbitrarily determine one of a plurality of the clock candidate frequencies or determine one of the plurality of the clock candidate frequencies based on settings.

Further, the mobile station core portion 600 may determine the state of an RF system included in the mobile terminal, and determine whether the RF system is using a radio frequency or a radio frequency band. More specifically, if the mobile terminal provides a mobile communication protocol conforming to LTE, the mobile station core portion 600 may determine whether the mobile terminal is transceiving a radio frequency signal of LTE frequency band and determine a reference frequency of a clock for the high-speed serial communication interface such that the clock does not significantly interfere the radio frequency signal of LTE frequency band (e.g., selecting a non-coherent clock with respect to the radio frequency signal of LTE frequency band). Thus, by recognizing the active state of an internal RF system, the mobile station core portion 600 may determine a non-coherent clock for e high-speed serial communication interface.

The mobile terminal may further include a clock information storing portion 400 in which non-coherent clock information is stored. The clock information storing portion 400 may be included in a non-volatile memory. The non-coherent clock information stored in the clock information storing portion 400 includes information for non-coherent clocks corresponding to each of the band channels of the RF systems. The non-coherent clock information may be stored prior to the release of the mobile terminal, e.g., during the manufacturing process. In this case, it may be possible to derive the non-coherent clock information by which noise can be avoided or reduced through a test value within a usable clock frequency range adjustable by considering frequencies of the RF systems configured in the mobile terminal. Further, the non-coherent clock information may be stored in the clock information storing portion 400 of the modem 500, and a tuning operation for optimizing a state of the peripheral device 200 to the derived clock may be performed. The clock setting portion 330 may check the non-coherent clock information stored in the clock information storing portion 400 and determine a non-coherent clock with respect to the assigned band channel as the non-coherent clock for use in the serial communication interface. The non-coherent clock with respect to the assigned band channel may be plural, and the clock setting portion 330 may set one among a plurality of the candidate non-coherent clocks. Throughout the specification, an operating frequency band of an RF system may also be referred to as the assigned band channel of an RF system, a frequency band of an RF system, the frequency of a communicated radio signal of an RF system, or the like.

As another embodiment, the non-coherent clock information may be generated by the clock setting portion 330. As described above, if the clock setting portion 330 retrieves a clock candidate frequency (non-coherent clock) having multiple frequencies which do not belong to a frequency range with respect to the assigned band channel, the clock setting portion 330 may generate the assigned band channel. Further, information for a clock candidate frequency with respect to the assigned band channel may be generated as the non-coherent clock information and stored in the clock information storing portion 400. Further, the clock setting portion 330 may update the non-coherent clock information stored in the clock information storing portion 400 if a new assigned band channel is generated. According to this method, when the clock setting portion 330 determines the non-coherent clock with respect to the assigned band channel, the clock setting portion 330 may confirm the non-coherent clock information stored in the clock information storing portion 400, and if there is no information for a corresponding non-coherent clock, the clock setting portion 330 may directly perform an operation of determining a clock having a frequency not generating a significant noise with respect to the assigned band channel among the clock candidate frequencies.

The assigned band channel may be changed after a clock for the serial communication interface has been set. The change may occur because the RF system synchronized by handover may be changed or communication frequencies may be changed when the current communication condition is not good. If the synchronized RF system itself or the assigned band channel is changed, the clock for the serial communication interface by the clock setting portion 330 may be set again since it may be confirmed by the synchronization confirmation portion 310 and the band channel confirmation portion 320.

Further, there may be more than two of the peripheral device 200. For example, there may be a display and a camera, and clocks for the serial communication interface with respect to each of the display and the camera may be different from each other. This may serve to optimize an operation of the peripheral device 200. In this case, the non-coherent clock information stored in the clock information storing portion 400 may be differently derived and stored by each of the peripheral device 200.

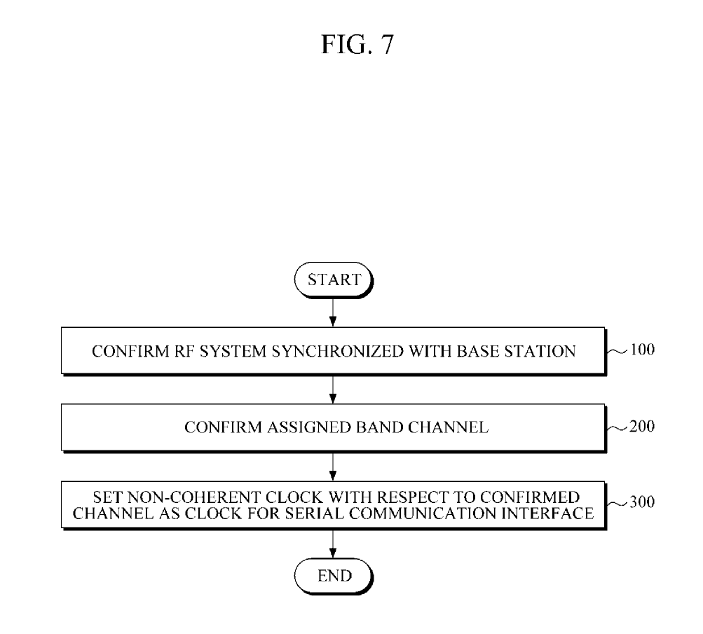

FIG. 7 is flowchart illustrating a clock setting method for a serial communication interface according to an exemplary embodiment of the present invention. FIG. 7 will be described as if performed by the mobile terminal shown in FIG. 6, but is not limited as such.

The processor 300 may monitor an RF system portion 100 and confirm that the RF system is synchronized with or communicating with a base station (operation 100). However, the RF system may communicate with an access point, evolved NodeB (eNodeB), and other wireless communication stations. Throughout the specification, an access point may be a communication point that includes e.g., a base station, an eNodeB, NodeB, base transceiver station, a cell, a Wi-Fi access point, GPS system, an external mobile terminal, a NFC transceiver, and the like. If the RF system synchronized with or communicating with the base station is confirmed, the processor 300 may confirm an assigned band channel (operation 200). There may be more than one of the assigned band channel. For example, CA (Carrier Aggregation) technology employed in the LTE communication technology, which boosts data communication speed by simultaneously using multiple RF bands. In this case, there may be more than two of the assigned band channel. If the assigned band channel is confirmed, the processor 300 may determine a non-coherent clock inducing multiplied frequencies which do not operate as noises with respect to the assigned band channel, and set the determined non-coherent clock as a clock for a serial communication interface (operation 300). As described above, the processor 300 may check a clock candidate frequency inducing multiplied frequencies which do not belong to a noise frequency range of the assigned band channel and determine a clock having the candidate frequency as the non-coherent clock, or determine the non-coherent clock using the non-coherent clock information stored in the clock information storing portion 400. Further, the two methods may be used together to determine the non-coherent clock. If the clock for the serial communication interface is set, the processor 300 may return to the operation 100, before communication is terminated due to the mobile terminal being powered down, to confirm whether the RF system is changed, and if the RF system is changed, the clock for the serial communication interface may be set again.

The above-described clock setting method may be applicable to other communication interfaces as well as the serial communication interface. For example, this method may also be applicable to the case in which a parallel communication interface between the processor 300 and the peripheral device 200 is implemented. More specifically, if a high-speed parallel communication interface for data transmission between the processor 300 and the peripheral device 200 is developed and a noise problem during a data communication using the high-speed parallel communication interface is generated, the above-described clock setting method may be applicable. For example, D-PHY physical layer protocol, M-PHY physical layer protocol, and other interface protocol of the MIPI standard and other types of communication interface protocol may also be applicable if the protocol is available for configuring a clock setting.

The methods and processes according to exemplary embodiments of the present invention can be implemented as computer readable codes in a computer readable record medium. The computer readable record medium includes all types of record media in which computer readable data are stored. Examples of the computer readable record medium include a ROM, a RAM, a CD-ROM, a magnetic tape, a floppy disk, and an optical data storage. In addition, the computer readable record medium may be distributed to computer systems over a network, in which computer readable codes may be stored and executed in a distributed manner. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. It will be apparent to those skilled in the art that various modifications and amount of change can be made in the present invention without departing from the spirit or scope of the invention. Thus, it is intended that the present invention cover the modifications and amount of changes of this invention provided they come within the scope of the appended claims and their equivalents.

What is claimed is:

1. A method for controlling a clock signal of a communication interface between components of a terminal, the method comprising:
determining a reference frequency of the clock signal, the reference frequency being determined based on an operating frequency band of a radio frequency (RF) system of the terminal; and
transmitting the clock signal via the communication interface using the determined reference frequency.

2. The method of claim 1, wherein the reference frequency of the clock signal is determined such that the reference frequency does not overlap the operating frequency band of the RF system.

3. The method of claim 1, wherein the reference frequency of the clock signal is determined such that a multiplied frequency of the reference frequency does not overlap the operating frequency band of the RF system.

4. The method of claim 1, wherein the reference frequency of the clock signal is determined such that an offset frequency of the reference frequency does not overlap the operating frequency band of the RF system and/or an offset frequency of a multiplied frequency of the reference frequency does not overlap the operating frequency band of the RF system.

5. The method of claim 1, further comprising:
determining whether the RF system transceives a radio signal using the operating frequency band of the RF system,
wherein the reference frequency of the clock signal is determined such that at least one of the reference frequency, a multiplied frequency of the reference frequency, an offset frequency of the reference frequency, and an offset frequency of the multiplied frequency does not overlap the operating frequency band of the RF system if the RF system transceives a radio signal using the operating frequency band of the RF system.

6. The method of claim 1, further comprising:
determining a first reference frequency as the reference frequency of the clock signal if a first RF system establishes a wireless connection using a first operating frequency band, the first reference frequency being a non-coherent frequency with respect to the first operating frequency band; and
determining a second reference frequency as the reference frequency of the clock signal if a second RF system establishes a wireless connection using a second operating frequency band, the second reference frequency being a non-coherent frequency with respect to the second operating frequency band.

7. The method of claim 1, wherein the reference frequency of the clock signal is a non-coherent frequency with respect to the operating frequency band of the RF system, the operating frequency band comprising one or more operating frequency bands.

8. The method of claim 1, further comprising:
monitoring an operating state of the RF system, the RF system comprising a plurality of RF systems having different operating frequency bands; and
adjusting the reference frequency of the clock signal with respect to another operating frequency band of the RF system if the other operating frequency band is activated.

9. The method of claim 1, further comprising:
retrieving, from a memory, mapping information between one or more non-coherent reference frequencies for the clock signal and the operating frequency band of the RF system.

10. The method of claim 1, further comprising:
activating the operating frequency band of the RF system; and
establishing a wireless connection with an access point using the activated operating frequency band, the wireless connection comprising at least one of a synchronization with the access point, a communication channel with the access point.

11. A mobile terminal to control a clock signal of a communication interface between components of the mobile terminal, the mobile terminal comprising:
a radio frequency (RF) system to transceive a radio frequency signal to and from an access point; and
a first component configured to determine a reference frequency of the clock signal, and to transmit the clock signal via the communication interface using the determined reference frequency, the reference frequency being determined based on an operating frequency band of the RF system of the mobile terminal.

12. The mobile terminal of claim 11, wherein the reference frequency of the clock signal is determined such that at least one of the reference frequency, a multiplied frequency of the reference frequency, an offset frequency of the reference frequency, and an offset frequency of the multiplied frequency does not overlap the operating frequency band of the RF system.

13. The mobile terminal of claim 11, wherein the first component determines a first reference frequency as the reference frequency of the clock signal if a first RF system of the mobile terminal establishes a wireless connection using a first operating frequency band, the first reference frequency being a non-coherent frequency with respect to the first operating frequency band; and
wherein the first component determines a second reference frequency as the reference frequency of the clock signal if a second RF system of the mobile terminal establishes a wireless connection using a second operating frequency band, the second reference frequency being a non-coherent frequency with respect to the second operating frequency band.

14. The mobile terminal of claim 11, wherein the reference frequency of the clock signal is a non-coherent frequency with respect to the operating frequency band of the RF system, the operating frequency band comprising one or more operating frequency bands.

15. The mobile terminal of claim 11, further comprising:
a monitoring portion to monitor an operating state of the RF system, the RF system comprising a plurality of RF systems having different operating frequency bands,
wherein the first component adjusts the reference frequency of the clock signal with respect to another operating frequency band of the RF system if the other operating frequency band is activated.

16. The mobile terminal of claim 11, further comprising:
a memory to store mapping information between one or more non-coherent reference frequencies for the clock signal and the operating frequency band of the RF system.

17. A mobile terminal to control a communication between components of the mobile terminal, the mobile terminal comprising:
a radio frequency (RF) system to transceive a radio frequency signal to and from an access point; and
a processor configured to determine a reference frequency of a signal between the components, the reference frequency being determined based on an operating frequency band of the RF system of the mobile terminal,
wherein one of the components transmits the signal via a communication interface between the components using the determined reference frequency.

18. The mobile terminal of claim 17, wherein the reference frequency of the signal is determined such that at least one of the reference frequency, a multiplied frequency of the reference frequency, an offset frequency of the reference frequency, and an offset frequency of the multiplied frequency does not overlap the operating frequency band of the RF system.

19. The mobile terminal of claim 17, wherein the reference frequency of the signal is a non-coherent frequency with respect to the operating frequency band of the RF system.

20. The mobile terminal of claim 17, further comprising:
a monitoring portion to monitor an operating state of the RF system, the RF system comprising a plurality of RF systems having different operating frequency bands,
wherein the one of the components adjusts the reference frequency of the signal with respect to another operating frequency band of the RF system if the other operating frequency band is activated.
